(19) United States
(12) Patent Application Publication
(10) Pub. No.: US 2026/0280057 A1
(43) Pub. Date: Sep. 17, 2026

(54) BUS BAR, BUS BAR MODULE, AND MANUFACTURING METHOD OF BUS BAR

(71) Applicant: YAZAKI CORPORATION, Tokyo (JP)

(72) Inventors: Katsunori Sato, Makinohara-shi (JP); Mariko Nakagawa, Makinohara-shi (JP); Yasuhiro Kominato, Makinohara-shi (JP); Seigo Mochizuki, Fujieda-shi (JP)

(21) Appl. No.: 19/551,564

(22) Filed: Feb. 26, 2026

(30) Foreign Application Priority Data
Mar. 11, 2025 (JP) 2025-037953

(51) Int. Cl. H01M 50/503; H01M 50/507; H02G 5/00

(52) U.S. Cl. CPC H01M 50/503; H01M 50/507; H02G 5/005

(57) ABSTRACT

A bus bar includes: two single-layer bus bars each constituted by a metal plate-like member; and a laminated bus bar having a plurality of metal plate-like members provided in an overlapping manner, the laminated bus bar provided across the two single-layer bus bars and electrically connecting the two single-layer bus bars, in which the laminated bus bar has overlapping regions arranged in an overlapping manner with the respective single-layer bus bars, the overlapping regions each provided with adhesive bonding portions in each of which one plate-like member of the laminated bus bar adheres to and is bonded to the plate-like member of the single-layer bus bar by pressing the laminated bus bar and the single-layer bus bars.

### CROSS-REFERENCE TO RELATED APPLICATION(S)

The present application claims priority to and incorporates by reference the entire contents of Japanese Patent Application No. 2025-037953 filed in Japan on March 11, 2025.

### BACKGROUND OF THE INVENTION

### 1. Field of the Invention

The present invention relates to a bus bar, a bus bar module, and a manufacturing method of a bus bar.

### 2. Description of the Related Art

As conventional technology relating to bus bars, bus bar modules, and manufacturing methods of a bus bar, for example, Japanese Patent Application Laid-open No. JP 2023 - 145 802 A discloses a bus bar, a bus bar module, and a manufacturing method of a bus bar, the bus bar including a first joint part joined to an output terminal of a first battery, a second joint part joined to an output terminal of a second battery, and a projecting portion disposed between the first joint part and the second joint part and projecting in a lamination direction of the batteries and the bus bar.

Meanwhile, in such a bus bar, a bus bar module, and a manufacturing method of a bus bar, for example, the electrical connection between electrode terminals is stabilized by absorbing a displacement of the electrode terminals due to expansion of a battery cell. In this respect, the bus bar, the bus bar module, and the manufacturing method of the bus bar have room for further improvement in the configuration for electrically connecting electrode terminals.

### SUMMARY OF THE INVENTION

The present invention has been made in view of the above circumstances, and an object thereof is to provide a bus bar, a bus bar module, and a manufacturing method of a bus bar capable of appropriately implementing electrical connection between electrode terminals.

In order to achieve the above mentioned object, a bus bar according to one aspect of the present invention includes two single-layer bus bars each constituted by a metal plate-like member; and a laminated bus bar having a plurality of metal plate-like members provided in an overlapping manner, the laminated bus bar provided across the two single-layer bus bars and electrically connecting the two single-layer bus bars, wherein the laminated bus bar has overlapping regions arranged in an overlapping manner with the respective single-layer bus bars, and the overlapping regions are each provided with an adhesive bonding portion in which one of the plate-like members of the laminated bus bar adheres to and is bonded to the plate-like member of the single-layer bus bar by pressing the laminated bus bar and the single-layer bus bars.

In order to achieve the above mentioned object, a bus bar module according to another aspect of the present invention includes a plurality of bus bars each electrically connected to electrode terminals of a battery cell among a plurality of battery cells arranged side by side; and a bus bar module case having a bus bar accommodating portion that accommodates each of the plurality of bus bars, wherein the plurality of bus bars each include: two single-layer bus bars each electrically connect to each of the electrode terminal of the adjacent battery cells and each constituted by a metal plate-like member; and a laminated bus bar having a plurality of metal plate-like members provided in an overlapping manner, the laminated bus bar provided across the two single-layer bus bars and electrically connecting the two single-layer bus bars, the laminated bus bar has overlapping regions arranged in an overlapping manner with the respective single-layer bus bars, and the overlapping regions are each provided with an adhesive bonding portion in which one of the plate-like members of the laminated bus bar adheres to and is bonded to the plate-like member of the single-layer bus bar by pressing the laminated bus bar and the single-layer bus bars.

In order to achieve the above mentioned object, a manufacturing method of a bus bar according to still another aspect of the present invention includes a preparation step of preparing two single-layer bus bars each constituted by a metal plate-like member and a laminated bus bar having a plurality of metal plate-like members provided in an overlapping manner; an arrangement step of providing the laminated bus bar across the single-layer bus bars such that overlapping regions are formed, the overlapping regions in which the laminated bus bar is disposed in an overlapping manner with each of the single-layer bus bars; and a pressing step of pressing the laminated bus bar and the single-layer bus bars in the respective overlapping regions to form adhesive bonding portions in which one of the plate-like members of the laminated bus bar adheres to and is bonded to the plate-like member of the single-layer bus bar.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a schematic configuration of a battery module to which a bus bar module according to an embodiment is assembled;

FIG. 2 is an enlarged perspective view of a portion P in FIG. 1;

FIG. 3 is a plan view illustrating a schematic configuration of a bus bar accommodating portion of a bus bar module case and a bus bar according to an embodiment;

FIG. 4 is a cross-sectional view taken along line IV-IV in FIG. 3;

FIG. 5 is a cross-sectional view taken along line V-V in FIG. 3; and

FIG. 6 is a flowchart illustrating a manufacturing method of the bus bar and the bus bar module according to the embodiments.

### DETAILED DESCRIPTION OF THE PREFERRED EMBODIMENTS

Hereinafter, embodiments of the present invention will be described in detail by referring to the drawings. Note that the invention is not limited by the embodiments. In addition, components in the following embodiments include those that can be easily replaced by those skilled in the art or those that are substantially the same.

### Embodiments

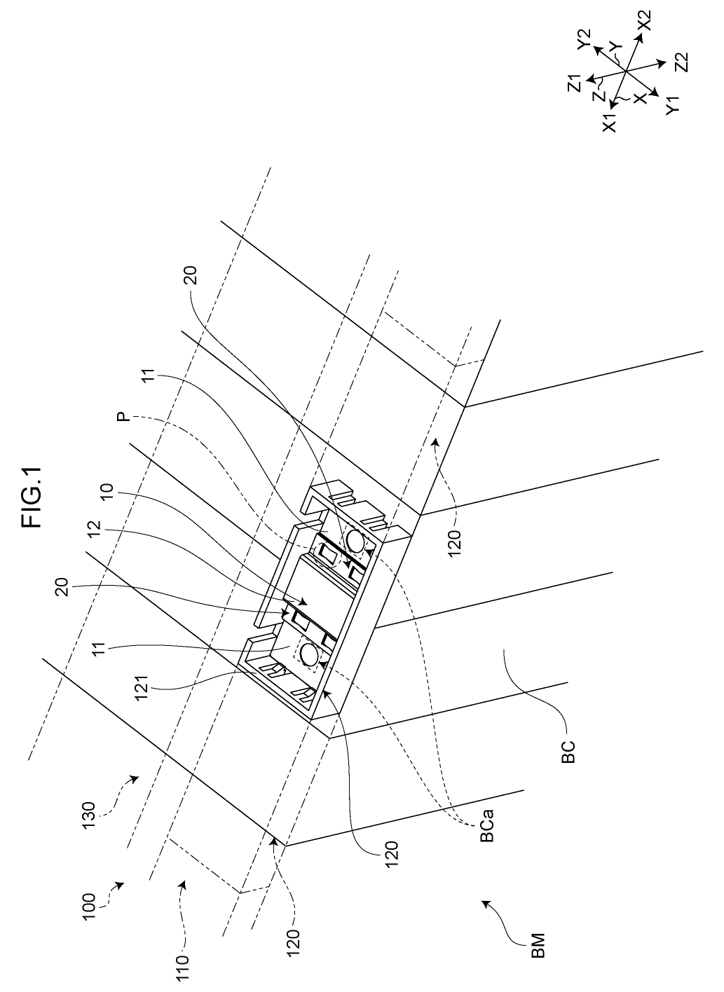

A bus bar 10 illustrated in FIG. 1 is provided in a bus bar accommodating portion 120 of a bus bar module case 110. A bus bar module 100 includes the bus bar 10 and the bus bar module case 110. The bus bar module case 110 includes the bus bar accommodating portion 120 and a wiring path 130 through which a wiring member is wired. A plurality of bus bar accommodating portions 120 are provided in the bus bar module case 110. A plurality of bus bars 10 are provided in respective bus bar accommodating portions 120.

A bus bar module 100 is assembled to a battery module BM. In the battery module BM, a plurality of battery cells BC are arranged side by side. The battery module BM constitutes a battery pack. The battery pack is mounted on, for example, a vehicle including a rotary machine as a drive source (such as battery electric vehicles (BEVs) and hybrid electric vehicles (HEVs)), and is used for supplying power to the rotary machine.

In addition, the wiring member wired in the wiring path 130 of the bus bar module case 110 can be a flat wiring member of a flexible printed board or the like. In the case where the wiring member is a flexible printed board, the wiring member has a base film, a cover lay, and a conductive layer. The base film and the cover lay are flexible insulating resin layers. The conductive layer is sandwiched and protected by the base film and the cover lay. The conductive layer is, for example, a conductive metal foil, and has a plurality of circuit patterns connected to the bus bar 10. A connector (not illustrated) is provided at an end portion of the wiring member. The connector can be fitted with a mating connector provided in a battery monitoring unit (not illustrated). The battery monitoring unit monitors the state of a battery cell BC.

In the following description, a direction in which a plurality of battery cells BC are arranged side by side is referred to as a first direction X, and two directions orthogonal to the first direction X are referred to as a second direction Y and a third direction Z. The third direction Z is a direction perpendicular to the top surface of the battery cell BC, which is a surface on which an electrode terminal BCa of the battery cell BC formed in a substantially rectangular parallelepiped shape is provided. In the following description, a first side in the first direction X is referred to as a first side X1, and a second side in the first direction X is referred to as a second side X2. Similarly, for the second direction Y, a first side Y1 and a second side Y2 are set, and for the third direction Z, a first side Z1 and a second side Z2 are set.

In each battery cell BC, an electrode terminal BCa is provided on each of the first side Y1 and the second side Y2 in the second direction Y on the surface on the first side Z1 in the third direction Z. In this drawing, only the electrode terminals BCa on the first side Y1 in the second direction Y are illustrated. One of the two electrode terminals BCa of each battery cell BC is a positive electrode, and the other is a negative electrode.

The bus bar 10 is electrically connected to the electrode terminals BCa of the battery cell BC. The bus bar 10 connects, for example, two adjacent battery cells BC in series. In this case, the bus bar 10 connects one electrode terminal BCa serving as a positive electrode and another electrode terminal BCa serving as a negative electrode. The bus bar 10 may be configured to connect two adjacent battery cells BC in parallel.

As illustrated in FIG. 1, the bus bar 10 includes two single-layer bus bars 11 and one laminated bus bar 12. Each of the single-layer bus bars 11 is formed of a plate-like member made of metal. Each of the single-layer bus bars 11 is electrically connected to each electrode terminal BCa of adjacent battery cells BC. Although described in detail later, the laminated bus bar 12 has a plurality of plate-like members made of metal and provided in an overlapping manner, and is provided across the two single-layer bus bars 11 to electrically connect the two single-layer bus bars 11.

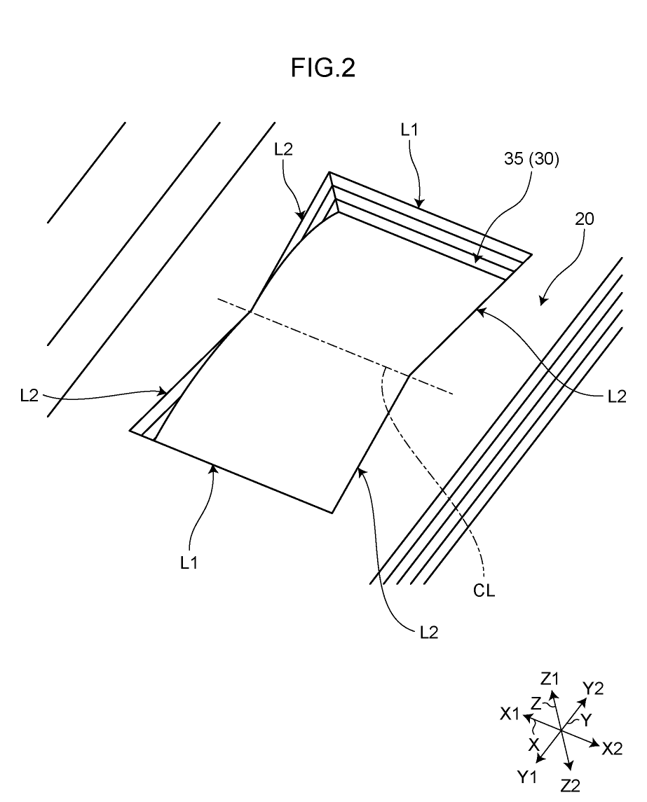

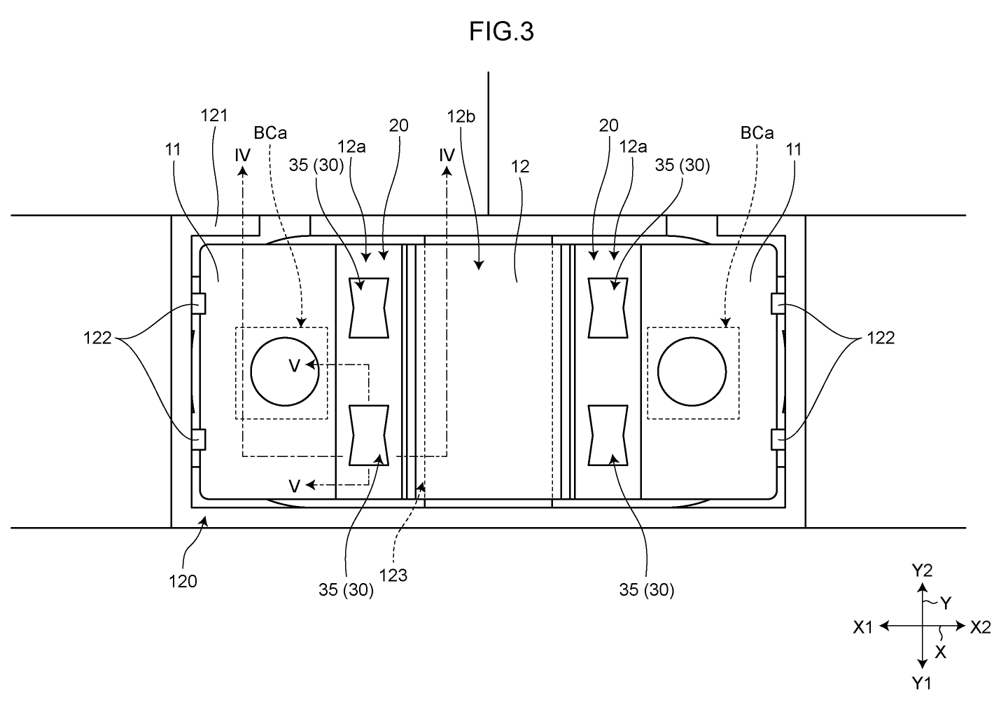

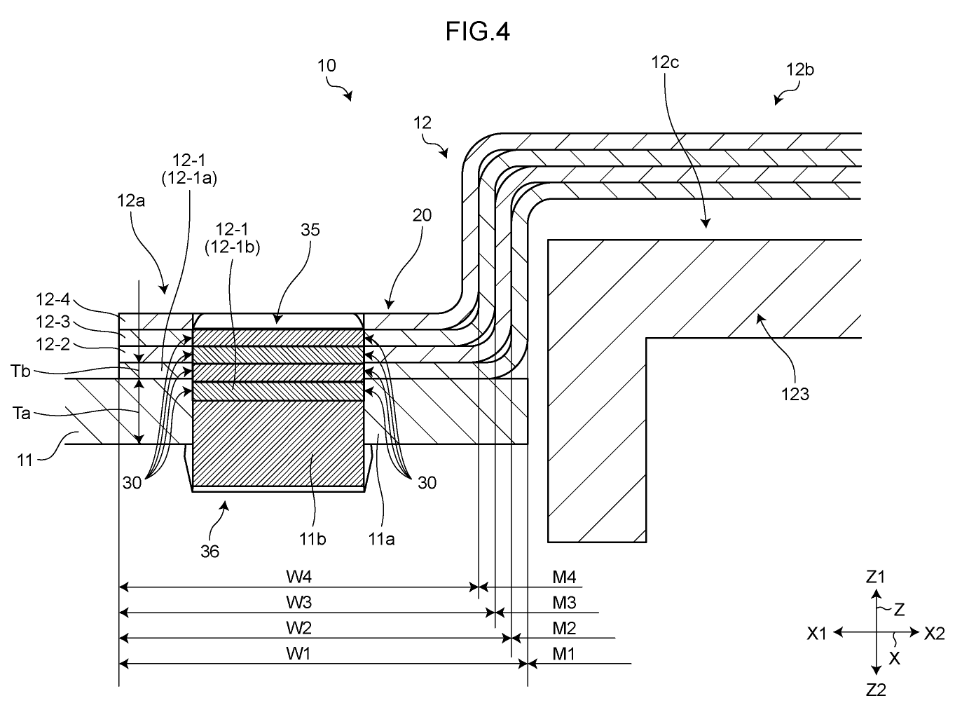

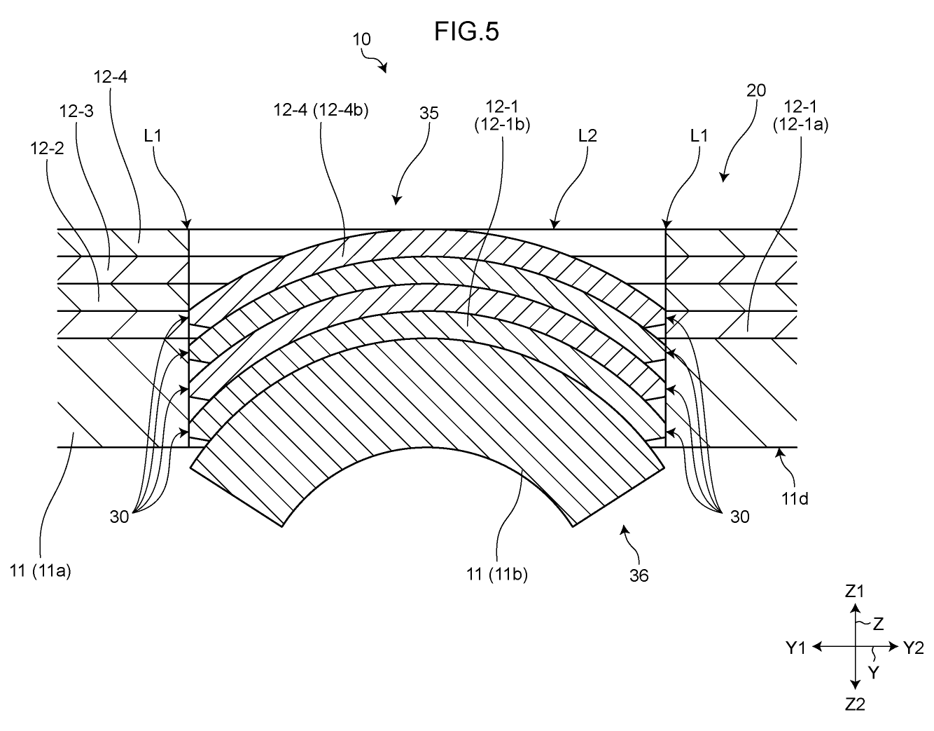

The laminated bus bar 12 has overlapping regions 20 arranged to overlap the single-layer bus bars 11. As illustrated in FIGS. 2 and 3, in an overlapping region 20, adhesive bonding portions 30 are included in which one of the plate-like members of the laminated bus bar 12 adheres to and is bonded to the plate-like member of a single-layer bus bar 11 (see also FIG. 4 and 5) with the laminated bus bar 12 and the single-layer bus bar 11 pressed (for example, by pressing).

The single-layer bus bar 11 is formed of one substantially long rectangular plate-like member. The single-layer bus bar 11 is formed with the second direction Y as the longitudinal direction. Meanwhile, as illustrated in FIG. 4, the laminated bus bar 12 is formed by overlapping a plurality of metal plate-like members. In the present embodiment, the laminated bus bar 12 is obtained by overlapping four plate-like members (a first plate-like member 12-1, a second plate-like member 12-2, a third plate-like member 12-3, and a fourth plate-like member 12-4 in this order from the second side Z2 in the third direction Z).

The laminated bus bar 12 is formed in a projecting shape having two flange portions 12a and a projecting portion 12b projecting to the first side Z1 in the third direction Z. In the projecting portion 12b, an internal space (a space 12c formed on the second side Z2 of the projecting portion 12b in the third direction Z) extends in the second direction Y. A flange portion 12a is formed in a substantially long rectangular flat plate shape with the second direction Y as the longitudinal direction.

In this example, the plate thickness Ta of a single-layer bus bar 11 (the plate-like member of the single-layer bus bar 11) is sufficiently thicker than the plate thickness Tb of each plate-like member of the laminated bus bar 12. Therefore, each of the plate-like members of the laminated bus bar 12 is more likely to be elastically deformed than the single-layer bus bars 11 are, for example, when a tensile force is applied in the first direction X.

The plurality of plate-like members of the laminated bus bar 12 are formed with different lengths in the first direction X in the projecting portion 12b and the flange portions 12a in such a manner as to overlap each other in the third direction Z. Specifically, the length (inner dimension M4) in the first direction X of the space 12c in the projecting portion 12b of the fourth plate-like member 12-4 is longer than the length (inner dimension M3) in the first direction X of the projecting portion 12b of the third plate-like member 12-3 by twice the plate thickness Tb of the plate-like members of the laminated bus bar 12. Similarly, the inner dimension M3 of the third plate-like member 12-3 is longer than an inner dimension M2 of the second plate-like member 12-2 by twice the plate thickness Tb. The inner dimension M2 of the second plate-like member 12-2 is longer than an inner dimension M1 of the first plate-like member 12-1 by twice the plate thickness Tb.

In addition, the lengths in the first direction X and the lengths in the second direction Y of the plate-like members of the laminated bus bar 12 are aligned. Therefore, in a flange portion 12a, a length W4 of the flange portion 12a of the fourth plate-like member 12-4 in the first direction X is shorter by the plate thickness Tb than a length W3 of the flange portion 12a of the third plate-like member 12-3 in the first direction X. Similarly, the length W3 of the third plate-like member 12-3 is shorter than a length W2 of the second plate-like member 12-2 by the plate thickness Tb. The length W2 of the second plate-like member 12-2 is shorter than a length W1 of the first plate-like member 12-1 by the plate thickness Tb.

In the present embodiment, the flange portion 12a of the laminated bus bar 12 on the first side X1 in the first direction X is provided to overlap the surface of the single-layer bus bar 11 on the first side X1 on the first side Z1 in the third direction Z. Similarly, the flange portion 12a of the laminated bus bar 12 on the second side X2 in the first direction X is provided to overlap the surface of the single-layer bus bar 11 on the second side X2 on the first side Z1 in the third direction Z. A portion where each flange portion 12a is provided to overlap a single-layer bus bar 11 is an overlapping region 20. In each of the two overlapping regions 20, pressed portions 35 are formed, the pressed portion 35 in which an adhesive bonding portion 30 is formed by pressing the laminated bus bar 12 and a corresponding single-layer bus bar 11. Pressed portions 35 are formed at two locations on the first side Y1 and the second side Y2 in the second direction Y in each of the overlapping regions 20.

In the present embodiment, as illustrated in FIG. 2, each of the pressed portions 35 has first cut lines L1, cut by pressing the laminated bus bar 12 and a single-layer bus bar 11, and second cut lines L2 cut by pressing the laminated bus bar 12 and the single-layer bus bar 11. A first cut line L1 is formed linearly in the first direction X. The first cut lines L1 are provided to face each other on the first side Y1 and the second side Y2 in the second direction Y across an axial line CL in the first direction X. Second cut lines L2 are formed from both ends of each of the first cut lines L1 toward the axial line CL such that the width in the first direction X decreases. Each of the second cut lines L2 extends to the vicinity of the axial line CL. Therefore, the laminated bus bar 12 and the single-layer bus bar 11 in the vicinity of the axial line CL are not cut.

The pressed portion 35 is pressed from the first side Z1 in the third direction Z, whereby the laminated bus bar 12 and the single-layer bus bar 11 are cut along the first cut lines L1 and the second cut lines L2. Therefore, the laminated bus bar 12 and the single-layer bus bar 11 in the pressed portion 35 are formed in a convex arc shape as illustrated in FIG. 5. By cutting the laminated bus bar 12 and the single-layer bus bar 11 in the pressed portion 35 along the first cut lines L1 and the second cut lines L2, frictional heat is generated between the cut plate-like members and the plate-like members that are not cut, whereby an adhesive bonding portion 30 to be bonded by adhesion is formed.

For example, as illustrated in FIG. 4 and 5, a cut first plate-like member 12-1b of the first plate-like member 12-1 of the laminated bus bar 12 in contact with the single-layer bus bar 11 is bonded to a plate-like member 11a of the single-layer bus bar 11, which is not cut, at the adhesive bonding portion 30. In this case, the adhesive bonding portion 30 is formed on a side surface of the first plate-like member 12-1 along the first cut line L1 and the second cut line L2. Similarly, in a cut fourth plate-like member 12-4b in the fourth plate-like member 12-4, an adhesive bonding portion 30 is formed with a first plate-like member 12-1a not cut in the first cut line L1. In addition, since the cut fourth plate-like member 12-4b in the fourth plate-like member 12-4 is formed in the convex arc shape at the second cut lines L2, an adhesive bonding portion 30 is formed from the first plate-like member 12-1 to the third plate-like member 12-3 which are not cut.

The pressed portion 35 (the cut laminated bus bar 12 and the plate-like member of the single-layer bus bar 11) is formed in a convex arc shape that is convex toward the first side Z1 in the third direction Z as viewed from the first direction X, whereby the side surfaces, having the convex arc shape, of each of the cut plate-like members of the laminated bus bar 12 face in the first direction X. Then, an adhesive bonding portion 30 is formed between the convex arc-shaped side surface of each of the plate-like members and the plate-like members of the laminated bus bar 12 and the single-layer bus bar 11 which are not cut. In other words, the axial line CL, where the cut plate-like members and the plate-like members which are not cut are connected, is provided in the first direction X, and the second cut lines L2 are formed in the second direction Y orthogonal to and intersecting the axial line CL. As a result, an adhesive bonding portion 30 is formed on a side surface of the arc shape which has an area larger than an adhesive bonding portion 30 formed on a first cut line L1 in the first direction X (axial line CL), and the adhesive bonding portion 30 is formed with a plurality of plate-like members by being formed in the arc shape. In particular, in the plate-like member 11a, which is not cut, of the single-layer bus bar 11, an adhesive bonding portion 30 is formed with a plurality of plate-like members of the laminated bus bar 12. Therefore, even if a tensile force in the first direction X is applied due to the thermal expansion of the battery cell BC, the bonding between the laminated bus bar 12 and the single-layer bus bar 11 can be firmly maintained.

In this manner, in the overlapping region 20, by pressing the laminated bus bar 12 and the single-layer bus bar 11, an adhesive bonding portion 30 is provided where one plate-like member (for example, the first plate-like member 12-1) of the laminated bus bar 12 adheres to and is bonded to the single-layer bus bar 11. In addition, in an adhesive bonding portion 30, one plate-like member (for example, the fourth plate-like member 12-4) of the laminated bus bar 12 adheres to and is bonded to other plate-like members (for example, the first plate-like member 12-1, the second plate-like member 12-2, and the third plate-like member 12-3) of the laminated bus bar 12.

In addition, in a cut plate-like member 11b of the single-layer bus bar 11, a convex portion 36 is formed which protrudes from a surface 11d of the single-layer bus bar 11 on the second side Z2 in the third direction Z (uncut plate-like member 11a). That is, in the pressed portion 35 which is a portion where the adhesive bonding portion 30 is provided, the convex portion 36 in which the single-layer bus bar 11 projects toward the second side Z2 (battery cell BC side) in the third direction Z is formed.

The bus bar 10 formed in this manner is accommodated in the bus bar accommodating portion 120 in the bus bar module case 110 of the bus bar module 100. A plurality of bus bar accommodating portions 120 are provided in the first direction X. As illustrated in FIG. 3, the bus bar accommodating portion 120 has an outer peripheral wall 121 formed in a substantially elongated rectangular shape in such a manner as to surround the outer periphery of the bus bar 10 having a substantially elongated rectangular shape elongated in the first direction X. The outer peripheral wall 121 is provided with locking protrusions 122 that lock and hold the bus bar 10 on the first side X1 and the second side X2 in the first direction X. In addition, the outer peripheral wall 121 is provided with a beam-like portion 123 (see also FIG. 4) provided in the second direction Y in such a manner as to pass through the space 12c in the projecting portion 12b of the laminated bus bar 12.

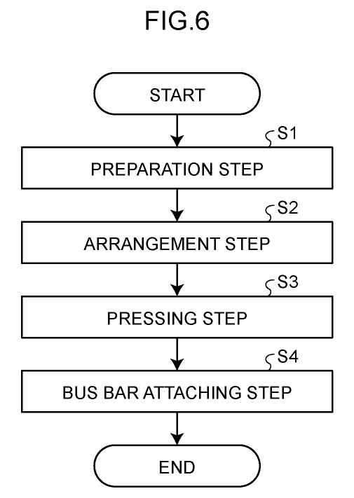

Next, the manufacturing method of the bus bar 10 will be described. As illustrated in FIG. 6, the manufacturing method of the bus bar 10 includes a preparation step (step S1), an arrangement step (step S2), and a pressing step (step S3). The manufacturing method of the battery module BM further includes a bus bar attaching step (step S4).

Preparation step (step S1); In the preparation step (step S1), two single-layer bus bars 11 each constituted by a metal plate-like member and the laminated bus bar 12 including a plurality of metal plate-like members provided in an overlapping manner are prepared. In the present embodiment, a single-layer bus bar 11 is formed in a substantially long rectangular flat plate shape. As the laminated bus bar 12, the first plate-like member 12-1, the second plate-like member 12-2, the third plate-like member 12-3, and the fourth plate-like member 12-4 each having flange portions 12a and a projecting portion 12b are prepared.

Here, in the laminated bus bar 12, the plurality of plate-like members (the first plate-like member 12-1, the second plate-like member 12-2, the third plate-like member 12-3, and the fourth plate-like member 12-4) are overlapped; however in the preparation step (step S1) before the pressing step (step S3), the plate-like members are separated from each other. However, for example, the plurality of plate-like members in the laminated bus bar 12 can be put together by welding, rivet connection, caulking, or the like. This makes it easier to handle the laminated bus bar 12 in the work of subsequent steps.

Arrangement step (step S2); In the arrangement step (step S2), the laminated bus bar 12 is provided across single-layer bus bars 11 such that overlapping regions 20 in which the laminated bus bar 12 is arranged to overlap the single-layer bus bars 11 are formed. Specifically, each flange portion 12a of the laminated bus bar 12 is disposed to overlap one of the single-layer bus bars 11.

Pressing step (step S3); In the pressing step (step S3), the laminated bus bar 12 and a single-layer bus bar 11 in each overlapping region 20 are pressed, whereby one plate-like member of the laminated bus bar 12 adheres to and is bonded to the plate-like member of the single-layer bus bar 11 to form an adhesive bonding portion 30. In the present embodiment, the laminated bus bar 12 and the single-layer bus bar 11 are cut along the first cut lines L1 and the second cut lines L2 facing each other across the axial line CL to form an adhesive bonding portion 30. In the pressing step (step S3), the adhesive bonding portions 30 are formed in which one plate-like member of the laminated bus bar 12 adheres to and is bonded to other plate-like members of the laminated bus bar 12.

Bus bar attaching step (step S4); In the bus bar attaching step (step S4), the bus bar 10 manufactured by joining the laminated bus bar 12 and the single-layer bus bars 11 by the adhesive bonding portions 30 is housed in the bus bar accommodating portion 120 of the bus bar module case 110. The bus bar 10 is fixed to and electrically connected to the electrode terminals BCa of each battery cell BC by laser welding or the like.

The bus bar 10 described above includes: two single-layer bus bars 11 each constituted by a metal plate-like member; and the laminated bus bar 12 having a plurality of metal plate-like members provided in an overlapping manner, the laminated bus bar 12 provided across the two single-layer bus bars 11 and electrically connecting the two single-layer bus bars 11, in which the laminated bus bar 12 has overlapping regions 20 arranged in an overlapping manner with the respective single-layer bus bars 11, the overlapping regions 20 each provided with adhesive bonding portions 30 in each of which one plate-like member of the laminated bus bar 12 adheres to and is bonded to the plate-like member of the single-layer bus bar 11 by pressing the laminated bus bar 12 and the single-layer bus bars 11. The bus bar module 100 includes a plurality of bus bars 10 and a bus bar module case 110 having bus bar accommodating portions 120. The manufacturing method of the bus bar 10 includes the preparation step (step S1), the arrangement step (step S2), and the pressing step (step S3).

As a result, for example, when the battery cell BC is thermally expanded in a state where the single-layer bus bars 11 are fixed to and electrically connected to the electrode terminals BCa of the battery cell BC, in the bus bar 10, the single-layer bus bar 11 on the first side X1 in the first direction X receives a force on the first side X1, and the single-layer bus bar 11 on the second side X2 receives a force on the second side X2. Even when such a tensile force is applied, in the bus bar 10, the laminated bus bar 12 in which the plurality of plate-like members are provided in an overlapping manner extends depending on the tensile force. Since the laminated bus bar 12 and the single-layer bus bars 11 are more firmly fixed to each other by the adhesive bonding portions 30, the laminated bus bar 12 and the single-layer bus bars 11 are hardly detached from each other, and thus it is possible to appropriately implement the electrical connection between the electrode terminals BCa.

The laminated bus bar 12 is formed in a projecting shape having the flange portions 12a, and the overlapping regions 20 are provided in the respective flange portions 12a. As a result, the bus bar 10 can receive the tensile force applied to the bus bar 10 in the first direction X by the deflection of the projecting portion 12b of the portion having the projecting shape. That is, when a tensile force is applied to the bus bar 10, the projecting portion 12b is elastically deformed in such a manner that inner dimensions M1 to M4 of the projecting portion 12b illustrated in FIG. 4 extend, and thus the electrical connection between the electrode terminals BCa can be further appropriately implemented.

In addition, in the adhesive bonding portions 30 formed in the pressing step (step S3), one plate-like member of the laminated bus bar 12 adheres to and is bonded to other plate-like members of the laminated bus bar 12. As a result, the plate-like members of the laminated bus bar 12 are more firmly bonded to each other, whereby the electrical connection between the electrode terminals BCa can be further appropriately implemented.

In addition, in the bus bar module 100, a convex portion 36, in which the plate-like member of a single-layer bus bar 11 protrudes toward the battery cell BC, is formed in the pressed portion 35 where the adhesive bonding portions 30 are provided. As a result, since the convex portions 36 formed by pressing are not arranged on the side (the first side Z1 in the third direction Z) where the bus bar 10 is exposed in the bus bar accommodating portion 120, it is possible to improve the workability without fingers or the like being caught in the work of fixing the bus bar 10 to the electrode terminals BCa or the like.

The bus bar, the bus bar module, and the manufacturing method of the bus bar according to the embodiments of the present invention described above are not limited to the embodiments described above, and various modifications can be made within the scope described in the claims.

In the above description, each of the plate-like members of the laminated bus bar 12 of the bus bar 10 is formed in the projecting shape provided with the projecting portion 12b, but may be formed in a flat plate shape. Moreover, the shape of the pressed portions 35 where the adhesive bonding portions 30 are formed is not limited to that of the present embodiment. For example, the axial line CL may be provided on the first side Y1 and the second side Y2 in the second direction Y, and cut lines extending in the second direction Y may be provided on the first side X1 and the second side X2 in the first direction X for each of the axial lines CL, and the laminated bus bar 12 and the single-layer bus bar 11 may be cut in such a manner as to separate between the axial lines CL facing each other. Although the convex portions 36 formed by pressing are obtained by projecting the single-layer bus bars 11 toward the electrode terminals BCa, the laminated bus bar 12 may be formed in such a manner as to project toward the opposite side of the electrode terminals BCa in the third direction Z.

The bus bar, the bus bar module, and the manufacturing method of the bus bar according to the present embodiment may be configured by combining the components of the embodiments and the modifications described above as appropriate.

In order to achieve the above object according to the present embodiment, a bus bar module of the present embodiment has an effect that electrical connection between electrode terminals can be appropriately implemented.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A bus bar, comprising:
two single-layer bus bars each constituted by a metal plate-like member; and
a laminated bus bar having a plurality of metal plate-like members provided in an overlapping manner, the laminated bus bar provided across the two single-layer bus bars and electrically connecting the two single-layer bus bars, wherein
the laminated bus bar has overlapping regions arranged in an overlapping manner with the respective single-layer bus bars, and
the overlapping regions are each provided with an adhesive bonding portion in which one of the plate-like members of the laminated bus bar adheres to and is bonded to the plate-like member of the single-layer bus bar by pressing the laminated bus bar and the single-layer bus bars.

2. The bus bar according to claim 1, wherein
the laminated bus bar is formed in a projecting shape having flange portions, and
the overlapping regions are provided in the flange portions.

3. The bus bar according to claim 1, wherein
in the adhesive bonding portion, one of the plate-like member of the laminated bus bar adheres to and is bonded to another plate-like member among the plate-like members of the laminated bus bar.

4. The bus bar according to claim 2, wherein
in the adhesive bonding portion, one of the plate-like member of the laminated bus bar adheres to and is bonded to another plate-like member among the plate-like members of the laminated bus bar.

5. A bus bar module, comprising:
a plurality of bus bars each electrically connected to electrode terminals of a battery cell among a plurality of battery cells arranged side by side; and
a bus bar module case having a bus bar accommodating portion that accommodates each of the plurality of bus bars, wherein
the plurality of bus bars each include:
two single-layer bus bars each electrically connect to each of the electrode terminal of the adjacent battery cells and each constituted by a metal plate-like member; and
a laminated bus bar having a plurality of metal plate-like members provided in an overlapping manner, the laminated bus bar provided across the two single-layer bus bars and electrically connecting the two single-layer bus bars,
the laminated bus bar has overlapping regions arranged in an overlapping manner with the respective single-layer bus bars, and
the overlapping regions are each provided with an adhesive bonding portion in which one of the plate-like members of the laminated bus bar adheres to and is bonded to the plate-like member of the single-layer bus bar by pressing the laminated bus bar and the single-layer bus bars.

6. The bus bar module according to claim 5, wherein
a convex portion in which the plate-like member of one of the single-layer bus bars protrudes toward the battery cell is formed in a portion where the adhesive bonding portion is provided.

7. A manufacturing method of a bus bar, the manufacturing method comprising:
a preparation step of preparing two single-layer bus bars each constituted by a metal plate-like member and a laminated bus bar having a plurality of metal plate-like members provided in an overlapping manner;
an arrangement step of providing the laminated bus bar across the single-layer bus bars such that overlapping regions are formed, the overlapping regions in which the laminated bus bar is disposed in an overlapping manner with each of the single-layer bus bars; and
a pressing step of pressing the laminated bus bar and the single-layer bus bars in the respective overlapping regions to form adhesive bonding portions in which one of the plate-like members of the laminated bus bar adheres to and is bonded to the plate-like member of the single-layer bus bar.

8. The manufacturing method of a bus bar according to claim 7, wherein
in the pressing step, the adhesive bonding portion is formed, the adhesive bonding portion in which one of the plate-like member of the laminated bus bar adheres to and is bonded to another plate-like member among the plate-like members of the laminated bus bar.
